(19) United States
(12) Patent Application Publication
(10) Pub. No.: US 2015/0351185 A1
(43) Pub. Date: Dec. 3, 2015

(54) INTELLIGENT PHOTOCELL FOR REMOTE MANAGEMENT AND CONTROL IN PUBLIC LIGHTING

(71) Applicant: TELEMETRIA INDUSTRIAL TELEMETRIK S.A.S., Medellin (CO)

(72) Inventors: GABRIEL JAIME MONTOYA CORREA, MEDELLIN (CO); OSCAR DARIO MONTOYA MONTOYA, MEDELLIN (CO)

(21) Appl. No.: 14/410,633

(22) PCT Filed: Jan. 15, 2013
(86) PCT No.: PCT/IB2013/050374

§ 371 Date: Dec. 23, 2014

(51) Int. Cl. H05B 33/08

(52) U.S. Cl. CPC H05B 33/0854

(57) ABSTRACT

A system which allows the management and control of the luminaire of public lighting, wherein said system consists of a high precision power meter which allows a report to be obtained of the main electrical variables and the power consumption (kW-h) of each of the luminaires is provided. Similarly, the system is formed by a device which is a hub, wherein the other devices are connected wirelessly to said hub via radio frequency, and at the same time the hub sends the collected information or data to the control center or main platform by an internet communication, through a GPRS cell modem. Moreover, for local measurement processes, the system of the present invention has an infrared communication module which operates under IrDA protocol and a non-volatile memory which allows data to be stored, during the time with no GPRS or wireless connection.

### CROSS-REFERENCE TO RELATED APPLICATIONS

This application claims priority to PCT Application No. PCT/IB2013/050374 having a filing date of Jan. 15, 2013, the entire content of which is hereby incorporated by reference.

### FIELD OF TECHNOLOGY

The following relates to a system which allows the remote management and control of the luminaire of public lighting, the system consisting of a high precision power meter which allows a report to be obtained of the main electrical variables and the power consumption (kW-h) of each of the luminaires. Similarly, the system is formed by a device is a hub, wherein the other devices are connected wirelessly to said hub via radio frequency, and at the same time the hub sends the collected information or data to the control center or main platform by an internet communication, using thereby a GPRS modem (General Packet Radio Service). Moreover, for local measurement processes, the system of embodiments of the present invention has an infrared communication module which operates under IrDA protocol and a non-volatile memory which allows data to be stored, during the time with no GPRS or wireless connection.

The system also comprises a plurality of sensors for controlling the luminaire at all time, within which there is environment luminosity level, noise level, amount of carbon dioxide CO2, and temperature. Similarly, according to the values of luminosity, the device acts on the luminaire by turning it on or off, as well as it also allows the use of a dimmer property of the power, which is associated to a reduction of the amount of lux emitted by the luminaire. The option of the dimmer property with the intelligent photocells is possible only in LED public lighting lamps and those with high pressure sodium with ballast or intelligent driver.

### BACKGROUND

Actually, the public lighting is made by a series of luminaires with a system of standard bulb, which have a very good illumination but the costs involved are very high due to the increased electrical power consumption. Similarly, the luminaires being currently used have a local control based on a photocell, in charge of turning on and off the lamp according to the time of the day (Night or Sunlight).

Currently the luminaires are controlled by the photocells as mentioned above, but since there is no remote and centralized system which allows to predict further problems or to identify real problems happening at the moment, it is translated in high maintenance costs, power consumption, reposition of the electrical assets, safety problems, etc. Below, there is a description of the current needs of the existing public lighting systems:
The state of the luminaires is not known in real time.
The real billing of the luminaires is not known, but though gauging.
There is no possibility to service the luminaires, in order to save power.
The working hours of the luminaires are not known.
In case of damages, the exact sites where an event occurred are not known.
Currently there is no possibility to perform a remote control on the luminaire.
There is no possibility to dimmer, due to the current legislation and to the technology of the current luminaires (Sodium). The dimmer in the new generation LED luminaires will allow to generate important energy savings. The current high pressure Sodium lamps require a change of reactor ballast to ballast or intelligent driver, which will allow it to generate energy savings since the illumination flow (dimmer) can be reduced in a controlled manner without being against the state legislation.
The light intensity in certain sites in the cities is not enough, which implies risks in relation to the safety of the citizens.

One of the important and significant aspects in the operation of a public lighting system currently used requires a series of people exclusively in charge of servicing or maintaining the luminaires, through direct observation which implies high personnel costs, a large amount of crews and basket cars and low efficacy in the solution of problems of the luminaires in field.

### SUMMARY

In this regard, there are a plurality of disclosures in the state of the art related to public lighting systems, namely to luminaires having defined input systems and having a light sensor which allow these to be autonomous in a certain way and to save costs that finally will be assumed by the final consumer, wherein these disclosures are directed to overcome the exiting needs.

Within such disclosures, we can find document JP 2005056807, which refers to a streetlight which can be easily moved or relocated by making a base platform also serve as a bench, disusing any installation work, reducing working cost by reducing a construction period, providing a pedestrian with a place for rest, unlike a conventional streetlight requiring an increasing man hour and cost for public work and electric work for laying a foundation platform under the ground, to say nothing of the difficulty of moving and relocation.

In the same way, this streetlight comprises a solar battery, a storage battery, a plurality of LED lighting tools, a pole, a base platform and so on, the pole equipped with the above devices is formed into a triangular shape, cross shape or the like in construction hard to be fallen down, enabling the pole be installed so as to stand straight even if the ground is slanted or rugged by an adjusting tool, thereby serving as the base platform, such as a bench for pedestrians. In this regard, the streetlight is made possible to move and relocate, and it can be fitted in the ground by an anchor system or the like in order to ensure the fixation thereof.

However, the streetlight of luminaire disclosed in this Japanese patent application features a series of disadvantages such as the fact of not being part of an integrated lighting system wherein the devices communicate to each other and with a control center, which increases the maintenance and repairing costs because it is necessary to have staff to constantly move for servicing these.

On the other hand, document CN 101225936 discloses a solar energy-saving street lamp belonging to technical field of public facility, comprising a base, a lamp stand, a light, a storage battery, a solar device and an automatic tracking controller, wherein the lighting is connected with the lamp stand by a heat pipe arranged in the lighting. A plurality of lamp holders for holding lamp caps are formed on upper and lower surface of a supporting disk in the lampshade of the lighting; a reflector is arranged above the lighting and a plurality of heat pipes arranged in the supporting disk to conduct heat. Thus, the solar energy-saving street lamp has the advantages that a complex circuit pipeline is not needed to be laid due to the solar for power supply, and it also has a LED illumination system which dissipates heat and has low consumption.

As with the japans patent mentioned above, this anteriority features the disadvantage of not having a main control system or master luminaire which allows the communication with the control center, avoiding thereby the moving costs and reviewing by specialized technical staff.

Now, the patent application WO 2010/014925 discloses an array of outdoor lighting operates mainly in independent mode wherein sensing, communication, and control processes take place between the various lights of the array, wherein additional communication and control may occur between the array and a control station by means of a master/coordinating node that transmits and receives signals to the control station via call phone or satellite. Thus, the system may be tied to the internet for dissemination of data and/or data analysis gathered by means of the multiple poles/devices of the array. The independent-array and/or the master-to-station network and communications may be adapted for energy-saving processes. In this regard, the device network system (matrix) comprises a master-slave system which allows a communication between the devices via wireless networks such as Wi-Fi, IR, etc. Moreover, each of the luminaires has a solar panel device for generating and storing e power.

On the other hand, document EP 2282108 mentions an energy saving road lighting device having telephone helpline functions, which includes a projector, which uses LED or high pressure discharge light sources, and one or more solar photovoltaic modules or panels connected with the respective photovoltaic generators; each projector and each photovoltaic module are mounted on a respective pole or street lamp used for the road public lighting and each projector includes a radio transceiver, a controller and an inverter, so as to balance the energy produced by each photovoltaic generator with the energy absorbed by the light sources and achieve greater energy saving, compared to the similar existing devices.

However, embodiments of the invention described in this anteriority also features the disadvantage of not having a communication system with the main control center in order to determine the proper time to service and/or review a specific luminaire and thus, to reduce the operation, maintenance and energy costs.

Finally, document CN 201925842 is related to a solar street lamp based on a wireless sensor network, wherein said solar street lamp mainly consists of a street lamp controller of an integrated wireless sensor network node, an LED street lamp, a solar cell module and a lamp post and the like, wherein the direct voltage sampling method is used to monitor the voltage of the solar cell module and a light sensitive resistor and a temperature and humidity sensor are used to collect the environmental parameters; and a chip CC2430 integrated with an integrated single-chip microcomputer 8051 and an RF module are used to control the LED street lamp and a DC/DC circuit, and the wireless sensor network with the function of self-organizing a network is established to realize real-time communication between the solar street lamps. These solar street lamps are designed to be widely used for urban and rural street lighting for a public lighting system in an urban community.

Although the invention described heretofore discloses the use of a RF module for the communication between the luminaires in order to have a control of both the environment variables and the functioning thereof, there is a disadvantage based on not having a system or device for the interconnection between a main luminaire and the control center, such as featured in the above mentioned documents.

According to the above, it is evident for those skilled in the art that there is a need in the state of the art, which relates to the design and implementation of a public lighting system having a plurality of luminaires in slave mode and at least one “master” luminaire, to which the slave ones are connected to in order to constantly report the state thereof for programming revision and/or maintenance, besides accounting in real time the power consumptions (kW-h) and can create balances of the consumptions and corresponding billing. Moreover, it is required that such public lighting system is cost efficient and its power consumption is minimum in order to avoid excessive electrical energy payments which are directly billed to the final users. Similarly, it is recommendable that the luminaire being part of the public lighting system is easy to manufacture, to install and to service, with commercially available elements and with a system which allows the luminaire to automatically turn on at a determined time when the sunlight is not enough to illuminate a street or area.

In addition, it is necessary that the lighting system and the luminaires to be located in roads or streets of a city or town have a high reliability communication system, with encryption levels for the safety of the information, electrical spectrum with transmission and reception band of free use, increased number of wireless connection nodes, based on the IEEE 802.15.4 standard, different to the traditional radiofrequency systems, in order to always be informing the control center about the state of the other luminaires and thus to known in a determined manner when a device fails or requires maintenance, reducing thereby the operation and servicing costs, avoiding unnecessary staff visits in order to perform a revision.

### BRIEF DESCRIPTION

Some of the embodiments will be described in detail, with reference to the following figures, wherein like designations denote like members, wherein:

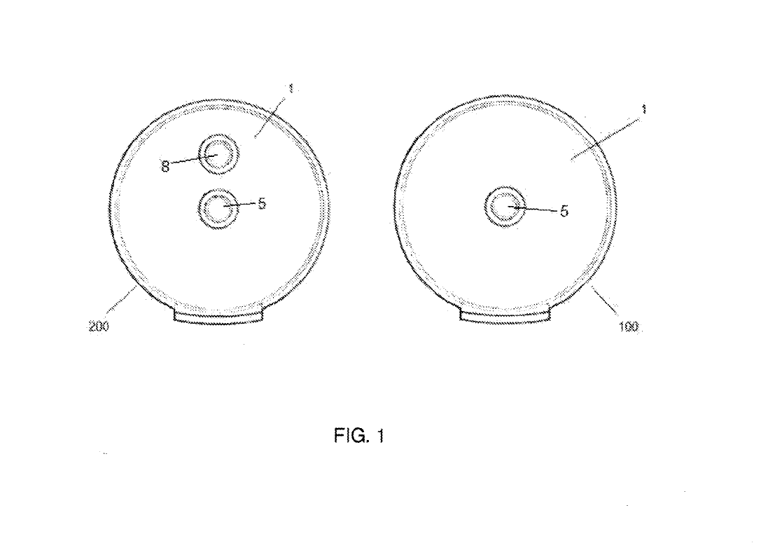

FIG. 1 corresponds to a top plan view of the two embodiments of photocell (master and slave) of the present invention.

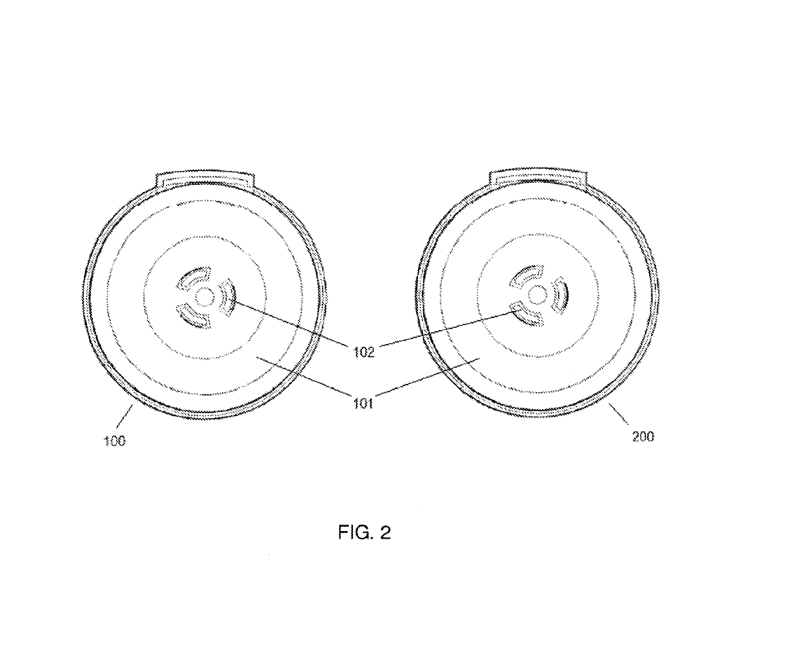

FIG. 2 corresponds to a bottom plan view of the photocells of FIG. 1.

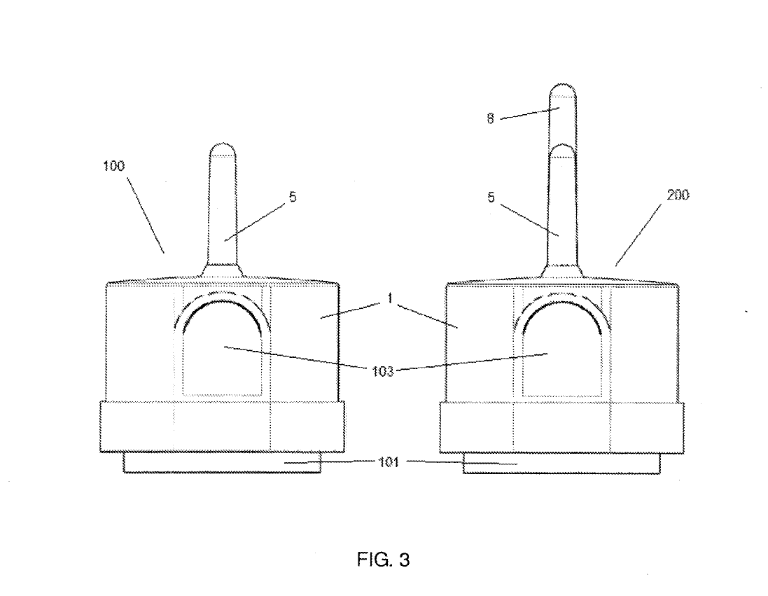

FIG. 3 corresponds to a front plan view of the photocells of FIGS. 1 and 2 including the outer cover.

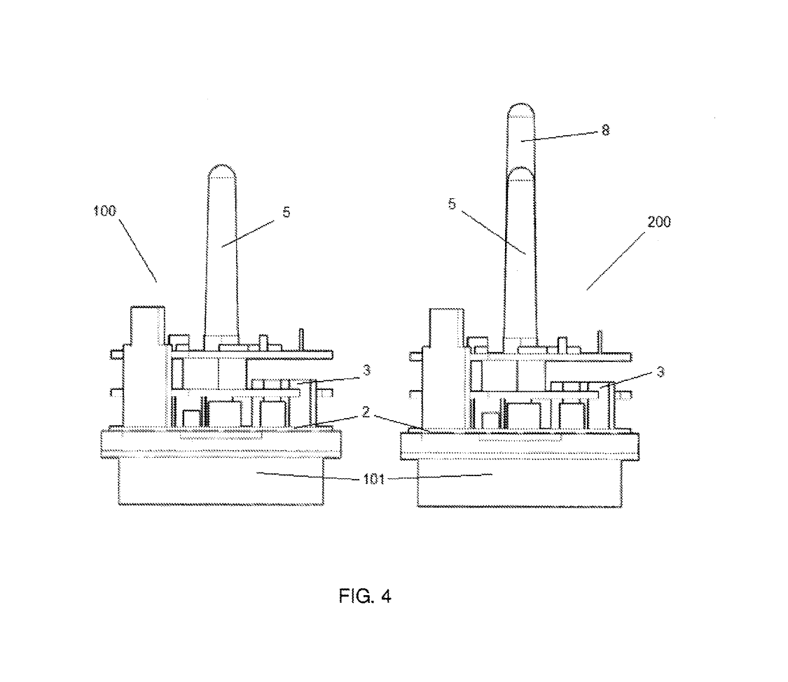

FIG. 4 corresponds to a front plan view of the photocells of FIGS. 1 and 2 without including the outer cover.

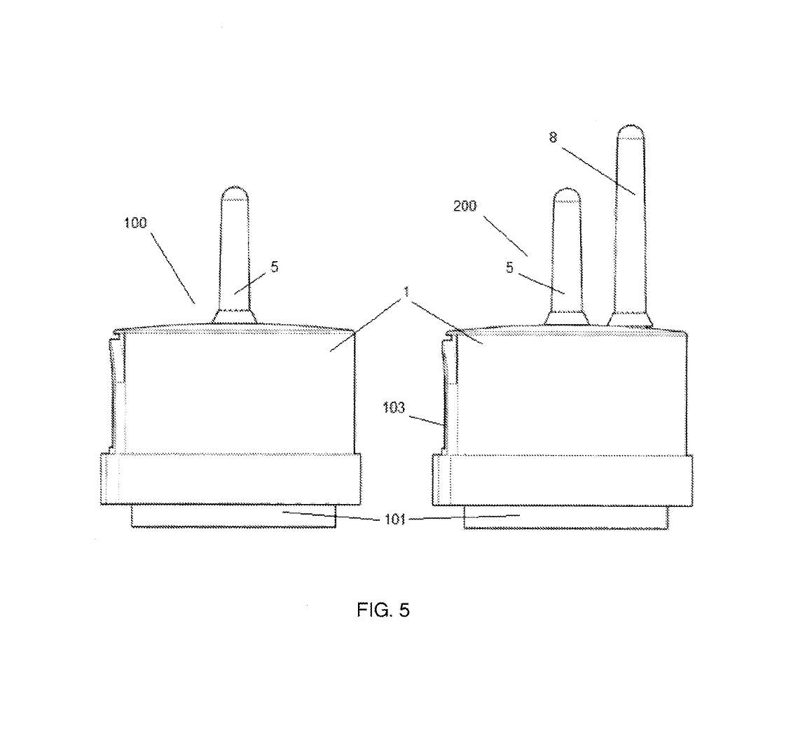

FIG. 5 corresponds to a side plan view of the photocells of FIGS. 1 and 2.

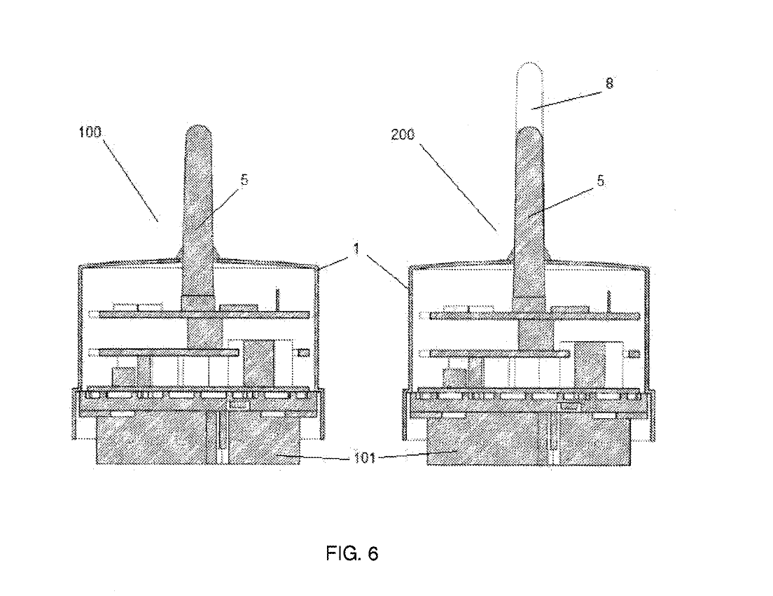

FIG. 6 corresponds to a front plan view of the photocells of FIGS. 1 and 2 making a cut through the line A-A.

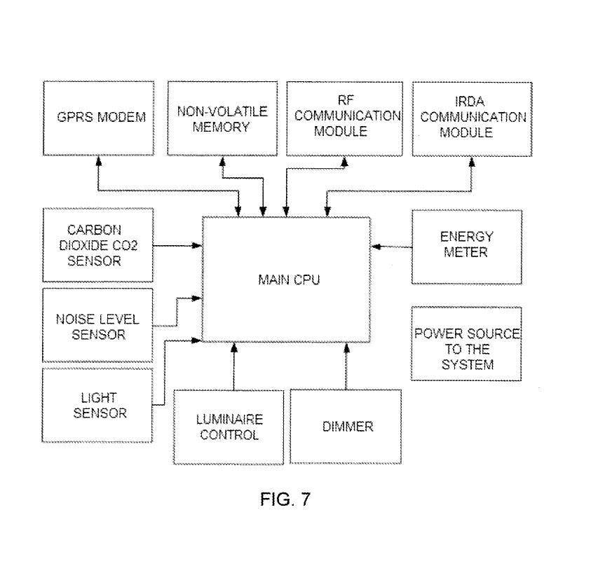

FIG. 7 corresponds to a block diagram wherein the relation and communication between the different electronic components of the system of the present invention are shown.

### DETAILED DESCRIPTION

The intelligent photocell system for management and control in public lighting systems of embodiments of the present invention comprises the following components or parts:
An outer cover (1) covering all the elements and/or parts of the system and being in charge of protecting against the weather.
A power source (2) which provides the power to the control system so its elements work properly, wherein this power source (2) takes the electric energy directly from the public lighting supply.
A main control system (3) which corresponds to a processing unit in charge of controlling all the elements of the system and analyzing the data received from the plurality of sensors.
An energy meter which allows to have a constant control over the power consumption of the luminaire where the control system is installed.
A RF communication module under the IEEE 802.15.4 standard (5) in charge of making the communication with other control systems located in luminaires nearby.
An IrDA communication module which allows to make a local measurement process by an operator and thus to analyze the state of the luminaire at all times.
A memory for storing data, which is adequate in case the communication with other luminaires or with the main control center is lost.
A sensors subsystem which allows to detect and measure external factors to the control system, whether for having an environmental control or to determine if it is appropriate to turn the luminaire on or off.
A dimmer module which allows to attenuate the intensity of the luminaire depending on the location thereof, the time of the day or any other factor determined by some defined parameters. The dimmer module only works in LED luminaires and those with high pressure Sodium with ballast or intelligent driver.
A luminaire control module which is in charge of turning the luminaire on or off depending on the instructions received by the main control system (3) according to the external factors and also by the instructions sent from the main control center.

In this regard, the control system of embodiments of the present invention is covered by the outer cover (1), which allows the electronic components to be protected, wherein such cover can be manufactured in any of the following materials: Polymethylmethacrylate (PMMA), polycarbonate (PC), polystyrene (PS), ULTEM and aluminum. These materials of the cover protect the electronic system of the photocell from the adverse conditions of the polluted environment and the weather.

As can be seen from FIGS. 1 to 3, the cover (1) is connected to a base (101) which is the base for the elements being part of the system. This base (101) comprises a connector (102) which corresponds to the control system of the current luminaires, wherein this connector (102) allows the simple connection (plug and play) to any kind of luminaire and thus to avoid the modification of the existing, which would imply high costs.

This cover (1) can be removed from the base (101), in order to provide access to all the electronic components which are part of the system of embodiments of the present invention.

The cover (1) also comprises a window (103) which allows the light to pass there through and to enter to the sensors subsystem and thus, it can be determined if the luminaire must be turned on or off according to the ambient light and the environment in which the luminaire is located. This window (103) comprises inside a small transparent sheet made in polycarbonate with UV protection, which allows the light to pass but does not allow the dust or any other external factors that may affect the electronic components located inside the cover (1) to pass.

In embodiments of the invention, the main control system (3) can be a microcontroller, a microprocessor, a DSP or a PLC or the like.

In a preferred embodiment, the system of embodiments of the present invention is configured to perform de function of being “master” and thus to be able to control the luminaires configured as “slave”, wherein in this “master” configuration the system further comprises an Internet communication module (8), based on a cell communication model which can be GPRS, EDGE, 3G, HSDPA or 4G LTE technology, which allows the luminaire control system to directly communicate with a main control center and thus to constantly report the state of all the luminaires being configured in slave mode, in order to monitor the luminaires and to determine if any of these require maintenance or in case of an incident or a malfunctioning it can be determined when this event occurs and which luminaire is the one that requires servicing, since each photocell has the satellite coordinate of each luminaire and this report is sent in real time to the main control system where the damaged luminaire is located in geo-referenced maps.

In this regard, the RF communication system (5) performs the function of creating a communication between several luminaires control systems which are located near to each other and thus to divide the public lighting system in quadrants, wherein each quadrant can have between 40 and 50 luminaires with its respective control system. In each quadrant the luminaires communicate with each other and send a series of data to the control system of the luminaire configured as master, i.e. the one having the internet communication module (8), so the master control system can determine a failure or exactly knows which luminaire is the one showing the error or the inconvenient and requires maintenance.

Now, the sensors subsystem is composed by a plurality of sensors, wherein said sensors can be used to monitor the environment variables or to exert a control on the luminaire. Thus, these sensors for monitoring the environment include temperature, humidity, noise level, carbon dioxide (CO2) sensors, and the control sensors include the ambient light level sensor, which basically corresponds to a photosensor, this indicates that light level in a determined moment so the main control (3) can determine if it is appropriate to turn the luminaire on or off, depending on the amount of light present at that time in the environment.

This light level sensor is located exactly behind the window (103) of the cover (1), so the light passing through the window (3) arrives directly to the sensor and the measurement is correct and the luminaire adequately turns on or off according to the programming that had been made in the main control (3), through a relay or device in charge of turning on or off the luminaire (luminaire control module).

In this regard, it can be said that the brain of the system is the main control (3) which is connected to all the elements of the system of embodiments of the present invention, whether for one way or double ways communication, in order to be able to take a decision of turning on the luminaire, turning of the luminaire, servicing or monitoring internal or external environmental factors according to the transmitted parameters.

Finally, the memory is a very useful device when storing data in case that there is a loss of communication with the other luminaires and the main control center, i.e. in case of a loss of cell signal by the internet communication module (8). This memory is preferably a non-volatile memory, such as EEPROM, FLASH or SD memory.

1. An intelligent photocell for controlling LED or high pressure Sodium luminaires for public lighting, comprising:
an outer cover covering the elements parts of the system;
a power source which provides the power to a main control system;
wherein the main control system cooperates with a central processing unit in charge of controlling all the elements of the system and analyzing data received from the plurality of sensors, connected directly to the elements of the system;
an energy meter for controlling the power consumption of at least one luminaire;
an RF communication module for communicating with other control systems located in luminaires nearby;
an IrDA communication module which allows to make a local measurement;
a memory for storing the data;
a sensors subsystem;
a dimmer module to attenuate the intensity of the luminaire; and
a luminaire control module in for turning the luminaire on or off depending on the instructions received by the main control system.

2. The photocell of claim 1, wherein the outer cover manufactured from a material (Polymethylmethacrylate (PMMA), polycarbonate (PC), polystyrene (PS), ULTEM and aluminum) resistant to sudden changes of temperature, excellent resistance to high energy radiation, excellent dielectric properties and thermal isolator due to the adverse conditions of the environment and the weather.

3. The photocell of claim 1, wherein the cover is connected to a base which is the base for the elements of the system and can be removed from the cover.

4. The photocell of claim 3, wherein the base comprises a connector which allows the simple connection to any kind of luminaire.

5. The photocell of claim 1, wherein the cover further comprises a window which allows the light to pass to the sensors subsystem, wherein said window comprises inside a sheet of a transparent material with UV protection.

6. The photocell of claim 1, wherein the main control system is a microcontroller, a microprocessor, a DSP or a PLC.

7. The photocell of claim 1, further comprising an Internet communication module, preferably a GPRS, EDGE, 3G, HSDPA or 4G LTE modem, which allows the luminaire control system to directly communicate with a main control center.

8. The photocell of claim 1, wherein the sensors subsystem is composed by a plurality of sensors, such as noise level, carbon dioxide (CO2), temperature, humidity and ambient light level sensors.

9. The photocell of claim 1, wherein the memory is a non-volatile memory, such as EEPROM, FLASH or SD memory.
